(19) United States
(12) Patent Application Publication
(10) Pub. No.: US 2014/0281966 A1
(43) Pub. Date: Sep. 18, 2014

(54) ELECTRONIC APPARATUS, AND CONTROL METHOD THEREFOR

(71) Applicant: CANON KABUSHIKI KAISHA, Tokyo (JP)

(72) Inventors: Hiroyuki Kajiyama, Kawasaki-shi (JP); Yuichiro Ishitsuka, Yokohama-shi (JP)

(73) Assignee: CANON KABUSHIKI KAISHA, Tokyo (JP)

(21) Appl. No.: 14/207,129

(22) Filed: Mar. 12, 2014

(30) Foreign Application Priority Data
Mar. 15, 2013 (JP) 2013-053247
Mar. 15, 2013 (JP) 2013-053248

(51) Int. Cl. G06F 3/0484; G06F 3/0482

(52) U.S. Cl. CPC G06F 3/04842; G06F 3/0482; G06F 3/04847
USPC 715/708; 715/771

(57) ABSTRACT

In order to enable users to use various functions via simple operations, a setting unit is configured to set any of setting values included in a first item in a hierarchy of a first setting menu and to set any of setting values included in a second item in a hierarchy of a second setting menu, and a control unit is configured to, according to a specific operation, switch to selection of a second setting value included in the second item in a case a first setting value included in the first item is selected, and to switch to selection of a fourth setting value included in the second item in a case a third setting value included in the first item is selected.

### BACKGROUND

1. Field

Aspects of the present invention generally relate to an electronic apparatus for setting a plurality of setting items, and a control method therefor.

2. Description of the Related Art

These days, electronic apparatuses provide/support multiple functions, and there is a large number of items which may be set. For example, with respect to an image capturing device such as a digital camera or a mobile phone with camera, items for setting conditions for photographing an image and other conditions are prepared. As the functions of an image capturing device increase, the setting items are also increased, and ways to set setting parameters of the increased setting items are also being proposed.

Japanese Patent Application Laid-Open No. 2011-217410 proposes to assign setting parameters of a plurality of setting items to one operation member, and to be selectable of setting values of the plurality of setting items according to operations on the one operation member. For example, assignment of a setting parameter (setting value) of an item regarding ISO sensitivity and a setting parameter (setting value) of an item regarding a self-timer to a right cursor key is disclosed. Parameter groups for image quality setting, “ISO auto”, “ISO 50”, “ISO 100”, and “ISO 200”, are sequentially changed by an on operation on the right cursor key, and when the right cursor key is pressed down thereafter, change to a parameter group for a self-timer for photograph setting is made.

When usable functions, setting item groups, and setting values increase, there are issues that a user does not notice some of the usable functions and setting items, or the method of setting is complicated, and the user cannot make full use of the functions of the electronic apparatus. Also with the method of Japanese Patent Application Laid-Open No. 2011-217410, many steps are necessary to select the setting value of a setting item whose place in the order of selection is low among a plurality of setting items assigned to one operation member, and there is a possibility that one does not notice that the setting item is assigned to the operation member. Moreover, when assigning a function to the operation member, if the existence of the function or the method of using the function is not known to the user, assignment to the operation member is not possible in the first place.

Japanese Patent Application Laid-Open No. 2004-048817 proposes photographing by performing setting of a camera based on the setting condition of the camera recorded in the header portion of an already photographed image.

However, with Japanese Patent Application Laid-Open No. 2004-048817, when setting is the same as that of an already photographed image, since a user does not perform an operation of changing the setting by a regular operation method, the user cannot learn the operation for achieving the same setting in the case there is no image that is already photographed. Accordingly, even when a beginner user likes a certain photograph setting after looking at an already photographed image, the user cannot improve his/her understanding of the setting, and the user cannot skillfully use, and perform setting of, the image capturing device by himself/herself.

### SUMMARY

According to an aspect of the present invention, an electronic apparatus includes a setting unit configured to set any of setting values included in a first item in a hierarchy of a first setting menu, and to set any of setting values included in a second item in a hierarchy of a second setting menu, and a control unit configured to perform control, according to a specific operation, so as to switch to selection of a second setting value included in the second item in a case a first setting value included in the first item is selected, and to switch to selection of a fourth setting value included in the second item in a case a third setting value included in the first item is selected.

Further features of the present disclosure will become apparent from the following description of exemplary embodiments with reference to the attached drawings.

### BRIEF DESCRIPTION OF THE DRAWINGS

FIGS. 1A and 1B are external views of a digital camera as an example of an electronic apparatus.

FIG. 2 is a configuration block diagram of a digital camera as an example of the electronic apparatus.

FIG. 3 is a flow chart of a photographing mode process.

FIG. 4 is a flow chart of a photographing setting process.

FIG. 5 is a flow chart of a creative filter setting process.

FIG. 6 is a flow chart of a picture style setting process.

FIG. 7 is a flow chart of an effect switching process.

FIGS. 8A to 8D are example displays of photographing setting screens.

FIGS. 9A to 9C are example displays where settings are switched by the effect switching process.

FIG. 10 is a correspondence table of a switching order and setting values in the effect switching process.

FIGS. 11A to 11D are example displays in a reproduction mode of an image photographed by an effect shot.

FIG. 12 is a flow chart of a reproduction mode process.

### DESCRIPTION OF THE EMBODIMENTS

An exemplary embodiment will be described in detail below with reference to the accompanying drawings.

It is to be noted that the following exemplary embodiment is merely one example and can be appropriately modified or changed depending on individual constructions and various conditions of apparatuses. Thus, the following exemplary embodiment is not seen to be limiting.

FIG. 1 shows an external view of a digital camera as an example of an electronic apparatus (display control device). A display unit 111 is a display that displays an image and various types of information. A shutter button 116 is an operation unit that issues an image capturing instruction. A mode dial 117 is an operation unit that switches between various modes. A main dial 50, an information display switching button 55, a reproducing button 57, a live view button 60, a photographing setting button 70, a direction button 80, and a SET button 90 are operation members that receives instructions from a user. Additionally, the direction button 80 includes an upward direction button, a downward direction button, a leftward direction button, and a rightward direction button. In the following, the upward direction button and the downward direction button are collectively referred to as upward/downward keys, and the leftward direction button and the rightward direction button are collectively referred to as right/left keys.

FIG. 2 shows a block diagram showing an example configuration of a digital camera 100 according to the present embodiment. In FIG. 2, a photographing lens 104 is a lens group including a zoom lens, and a focus lens. The lens group may be interchangeable lenses which may be attached or detached. A shutter 105 is a shutter having an aperture function. An image capturing unit 106 is an image sensor configured from a CCD, a CMOS element or the like that converts an optical image into an electrical signal. An A/D converter 107 converts an analog signal into a digital signal. The A/D converter 107 is used to convert an analog signal output from the image capturing unit 106 into a digital signal. A barrier 103 prevents an image capturing system including the photographing lens 104, the shutter 105, and the image capturing unit 106 from getting dirty or from breaking, by covering the image capturing system, of the digital camera 100, including the photographing lens 104.

An image processing unit 102 performs predetermined pixel interpolation, resize processing such as reduction, or color conversion processing on data from the A/D converter 107 or data from a memory control unit 108. Also, the image processing unit 102 performs predetermined calculation processing using captured image data, and a system control unit 101 performs exposure control or ranging control based on the calculation result obtained. Then, AF (autofocus) processing according to a TTL (through-the-lens) method, AE (auto exposure) processing, or EF (pre-flash) processing is performed. The image processing unit 102 further performs predetermined calculation processing using captured image data, and performs AWB (auto white balance) processing according to the TTL method based on the calculation result obtained.

Output data from the A/D converter 107 is written in a memory 109 through the image processing unit 102 and the memory control unit 108, or directly through the memory control unit 108. The memory 109 stores image data obtained by the image capturing unit 106 and converted into digital data by the A/D converter 107, and image data for being displayed on the display unit 111. The memory 109 has enough memory capacity to store a predetermined number of still images, or a moving image and audio of a predetermined length.

Moreover, the memory 109 serves also as a memory for image display (video memory). A D/A converter 110 converts data for image display stored in the memory 109 into an analog signal, and supplies the signal to the display unit 111. Then, image data for display written in the memory 109 is displayed by the display unit 111 through the D/A converter 110. The display unit 111 performs display on a display device such as an LCD, according to an analog signal from the D/A converter 110. The function of an electronic viewfinder is achieved by digital signals which are A/D converted by the A/D converter 107 and accumulated in the memory 109 being analog-converted by the D/A converter 110 and being consecutively transferred to, and displayed on, the display unit 111. That is, through image display (live view display) is enabled.

A non-volatile memory 114 is a memory allowing electrical erasure/recording, and an EEPROM or the like is used therefor, for example. The non-volatile memory 114 stores constants, programs and the like for operation of the system control unit 101. The programs here refer to the programs for performing various flow charts, described later, of the present embodiment.

The system control unit 101 controls the entire digital camera 100. Each process of the present embodiment described later is realized by the programs recorded in the non-volatile memory 114 described above being executed. The reference numeral 113 is a system memory, and a RAM is used therefor. Constants, variables, programs read from the non-volatile memory 114, and the like for operation of the system control unit 101 are decompressed in the system memory 113. Moreover, the system control unit also performs display control by controlling the memory 109, the D/A converter 110, the display unit 111, and the like.

A system timer 112 is a timing unit for measuring time used for various types of control, and the time of a built-in clock.

A first shutter switch 116a (SW1) is turned on in the middle of an operation, i.e. half press (photographing preparation instruction), of a shutter button 116 provided to the digital camera 100, and generates a first shutter switch signal SW1. An operation such as AF (autofocus) processing, AE (auto exposure) processing, AWB (auto white balance) processing, EF (pre-flash) processing, or the like is started by the first shutter switch signal SW1. A second shutter switch 116b is turned on when the operation of the shutter button 116 is completed, i.e. full press (image capturing instruction), and generates a second shutter switch signal SW2. The system control unit 101 starts, by the second shutter switch SW2, an operation of a series of photographing processes from reading of a signal from the image capturing unit 106 to writing of image data in a recording medium 123.

The mode selection switch 117 switches the operation mode of the system control unit 101 to one of a plurality of still image recording modes, a movie recording mode, a reproduction mode, and the like (performs mode setting). Modes included in the still image recording modes are roughly classified into a creative photographing zone where exposure is determined and photograph setting is performed mainly by the user, and a basic photographing zone where exposure (shutter speed, aperture value, and the like) is automatically determined and photograph setting is performed mainly by the digital camera 100. Each class includes the following photographing modes (operation modes including a first operation mode, a second operation mode, and a third operation mode).

[Creative Photographing Zone]
Program AE mode (P mode)
Shutter priority AE mode (Tv mode)
Aperture priority AE mode (Av mode)
Manual exposure mode (M mode)

[Basic Photographing Zone]
Flash-off mode
Creative auto mode (CA mode)
Portrait mode
Landscape mode
Close-up (macro) mode
Sports mode
Special scene mode (SCN mode)

Moreover, after setting the special scene mode by the mode selection switch 117, switching to any of the following modes is performed by using another operation member.

[Special Scene Mode (SCN Mode)]
Kids mode
Food mode
Candle light mode
Night portrait mode
Handheld night mode
HDR (high dynamic range) backlight correction mode

Direct switching to any of the modes included in a still image photographing mode is performed by using the mode selection switch 117. Or, after switching to the still image photographing mode by the mode selection switch 117, switching to any of the modes included in the still image photographing mode may be performed by using another operation member. In the same manner, a plurality of modes may be included in a movie recording mode.

An operation unit 115 includes various operation members such as the main dial 50, the information display switching button 55, the reproducing button 57, the live view button 60, the photographing setting button 70, the direction button 80, the SET button 90, and the like. The operation members of the operation unit 115 are assigned with a function as appropriate on a per-scene basis by selection/operation of various function icons displayed on the display unit 111, and serve as various function buttons. As the function buttons, there are a termination button, a return button, an image feeding button, a jump button, a narrowing-down button, an attribute change button, and the like, for example. For example, when a menu button is pressed down, a menu screen on which various settings are enabled is displayed on the display unit 111. A user can intuitively perform various settings by using the menu screen displayed on the display unit 111, and the direction button 80 and the SET button 90.

A power supply control unit 119 is configured from a battery detecting circuit, a DC/DC converter, a switching circuit that switches blocks to be energized, and the like, and performs detection regarding attachment of a battery, the type of the battery, and the remaining battery level. Also, the power supply control unit 119 controls the DC/DC converter based on the detection result and an instruction from the system control unit 101, and supplies necessary voltage to each unit including the recording medium 123 for a necessary period of time.

A power supply unit 120 is configured from a primary battery such as an alkaline battery or a lithium battery, a secondary battery such as a NiCd battery, a NiMH battery, or a Li battery, an AD adapter, or the like. A recording medium I/F 122 is an interface to the recording medium 123 such as a memory card or a hard disk. The recording medium 123 is a recording medium such as a memory card for recording photographed images, and is configured from a semiconductor memory, a magnetic memory or the like.

The digital camera 100 allows setting of a creative filter function, a picture style function, an ambience function, or an effect shot function, and photographing by the same. Setting values of the functions can be set in the hierarchy of different respective setting menus (a first setting menu, a second setting menu, a third setting menu, a fourth setting menu).

The creative filter is a function of applying a special image processing effect on a captured image, and recording the image. As the filter effects, the creative filter includes rough monochrome, soft focus, toy camera, fisheye, and the like. The rough monochrome is a mode for generating a monochrome photograph with a rough texture. The contrast is adjusted by the user adjusting the filter level, and the feel of roughness can be changed. The soft focus is a mode for generating an image with a soft impression. Setting of a blur is adjusted by the user adjusting the filter level, and the feel of softness can be changed. The toy camera is a mode for generating an image of a unique color tone as if by a toy camera. The color tone is adjusted by the user adjusting the filter level, and the feel of a color can be changed. The fisheye is a mode of applying image processing of widening the central portion of an image and narrowing the peripheral portion so as to achieve a barrel-like distortion such that an image which looks as if it is photographed with a fisheye lens is achieved. The intensity of the distortion can be changed by the user adjusting the filter level. The creative filter can be used (set) when the HDR backlight correction mode or the handheld night mode is set, and the filter is invalid and cannot be set in other photographing modes.

The picture style is a function of adjusting the sharpness, the contrast, the hue, and the color saturation to be optimum, for each scene (item) that is selected, such as portrait, landscape, monochrome or the like. The picture style is set to auto in a photographing mode included in the basic photographing zone, and setting of an arbitrary scene (item) or setting value by the user is not allowed. In the case of the photographing modes included in the creative photographing zone, i.e. the P mode, the Tv mode, the Av mode, and the M mode, an arbitrary item among a plurality of scenes (items) such as portrait, landscape, monochrome and the like can be set. Also, setting values for the sharpness, the contrast, the hue, the color saturation, and the like for a scene can be adjusted and set.

According to the ambience function (Shoot by Ambience Selection), the user selects one of the options describing desired impressions of photographs. The options include “sharp and vivid”, “softer and more dainty”, and the like. According to the function, exposure correction or white balance correction is automatically performed based on the hue or the color density according to the selected option. The ambience function can be used (set) in the case the following modes are set among the photographing modes included in the basic photographing zone. In other modes, the function is invalid and cannot be set. The creative auto mode (CA mode), the portrait mode, the landscape mode, the close-up (macro) mode, the sports mode. Among the photographing modes included in the special scene mode (SCN mode), the kids mode, the night portrait mode, the handheld night mode.

The effect shot is a function allowing the user to select one of options including at least one of pre-set setting values of the creative filter, the picture style, and the ambience function, and to perform photographing. The order of selection of the options of the effect shot is determined in such a way that cyclic selection of presets which are setting values that can be set according to the creative filter, the picture style, and the ambience function is enabled. By using the effect shot, even a user who is not familiar with each of the functions of the creative filter, the picture style, and the ambience function can casually use typical settings without performing an operation of setting each detail item of each function, and perform photographing. The effect shot can be used (set) when the CA mode is set, and in other photographing modes, the effect shot is invalid and cannot be set.

In the following, which of the functions described above can be used in each photographing mode is summed up. A letter “C” is given to the photographing modes which can use the creative filter function, “P” is given to the photographing modes which can use the picture style functions, except for the auto, “A” is given to the photographing modes which can use the ambience functions, and “E” is given to the photographing modes which can use the effect shot.

[Creative Photographing Zone]
Program AE mode (P mode) . . . “C”, “P”
Shutter priority AE mode (Tv mode) . . . “C”, “P”
Aperture priority AE mode (Av mode) . . . “C”, “P”
Manual exposure mode (M mode) . . . “C”, “P”

### [Basic Photographing Zone]

Flash-off mode . . . “C”
Creative auto mode (CA mode) . . . “C”, “A”, “E”
Portrait mode . . . “C”, “A”
Landscape mode . . . “C”, “A”
Close-up (macro) mode . . . “C”, “A”
Sports mode . . . “C”, “A”

[Special Scene Mode (SCN Mode)]
Kids mode . . . “C”, “A”
Food mode . . . “C”, “A”
Candle light mode . . . “C”
Night portrait mode . . . “C”
Handheld night mode . . . “A”
HDR (high dynamic range) backlight correction mode . . . None

In the following, the method of using the creative filter function, the picture style function, the ambience function, and the effect shot function in photographing will be described.

<Photographing Mode Process>

FIG. 3 is a flow chart of a photographing mode process of the digital camera 100. This process is realized by the programs recorded in the non-volatile memory 114 being decompressed in the system memory 113, and the system control unit 101 executing the programs. The process of FIG. 3 is started when the digital camera 100 is started up in the photographing mode.

In S301, first, the system control unit 101 determines whether or not the photographing mode is started up with live view being ON. In the case live view is on, the process proceeds to S302; otherwise, the process proceeds to S303.

In S302, the system control unit 101 causes a mirror for guiding object light to an optical viewfinder to be held up (mirror lock-up), and guides the object light to the image capturing unit 106. Then, through images that are continuously photographed by the image capturing unit 106 are displayed on the display unit 111 as a live view image, and live view display is performed.

In S303, the system control unit 101 determines whether or not the photographing setting button 70 is pressed down. In the case it is determined that the photographing setting button 70 is pressed down, the process proceeds to S304 and a photographing setting process (described later with reference to FIG. 4) is performed; otherwise, the process proceeds to S305.

In S305, the system control unit 101 determines whether or not the mode dial 117 is operated. In the case it is determined that the mode dial 117 is operated, the process proceeds to S306, and the photographing mode is changed according to the operation of the mode dial 117. In the case the mode dial 117 is not operated, the process proceeds to S307.

In S307, the system control unit 101 determines whether or not the live view button 60 is pressed down. In the case the live view button 60 is pressed down, the process proceeds to S308. In S308, in the case the live view is off, the system control unit 101 turns on the live view, holds the mirror up, and performs live view display. In the case the live view is on, it is switched off, the mirror is brought down, and the object light is guided to the optical viewfinder. Additionally, in the live view display, a live view image on which image processing, described later, reflecting each setting value set by the creative filter, the picture style, the ambience function, and the effect shot is performed is assumed to be displayed.

In S309, the system control unit 101 determines whether or not the main dial is operated. In the case the main dial is operated (in the case a certain operation is performed), the process proceeds to S310; otherwise, the process proceeds to S313.

In S310, the system control unit 101 refers to the system memory 113, and determines whether or not the effect shot is currently on. In the case the effect shot is on, the process proceeds to S311; otherwise, that is, in the case the effect shot is off, the process proceeds to S312. In S311, the system control unit 101 performs an effect switching process (described later with reference to FIG. 7) for switching the effect of the effect shot according to a rotation operation of the main dial. In S312, the system control unit 101 performs a process according to the rotation operation of the main dial 50, according to the current photographing mode. For example, when the current photographing mode is the shutter speed priority mode (Tv mode), the setting of the shutter speed is changed according to the rotation operation of the main dial 50.

In S313, the system control unit 101 determines whether or not the SW1 is turned on. In the case the SW1 is turned on, the process proceeds to S314; otherwise, the process proceeds to S321. In S314, the system control unit 101 performs the autofocus processing (AF) and the automatic exposure control processing (auto exposure/AE) as a photographing preparation processing. In S315, the system control unit 101 determines whether or not the SW2 is turned on. In the case the SW2 is turned on, the process proceeds to S317; otherwise, the process proceeds to S316. In S316, the system control unit 101 determines whether or not the SW1 is still on. In the cases the SW1 is still on, the process proceeds to S315, and in the case the SW1 is not on, that is, in the case the shutter button 116 is released, the process proceeds to S321.

In S317, the system control unit 101 performs photographing by the image capturing unit 106, and temporarily stores image data obtained by the photographing in the memory 109. The photographing here is photographing for recording a photographed image as an image file, and is thus referred to as main photographing so as to be distinguished from the photographing for performing the live view display described above.

In S318, the system control unit 101 applies image processing on the image data temporarily stored in the memory 109 in S317, by controlling the image processing unit 102. As the image processing here, image processing based on the contents set by the creative filter function, the picture style function, the ambience function, or the effect shot function is performed.

In S319, the system control unit 101 performs quick review display of displaying the image on which image processing is performed in S318, on the display unit 111 for a predetermined period of time (about 2 seconds). Additionally, when the setting of the quick review display is set to off in advance, this process may be omitted.

In S320, the system control unit 101 records the image on which image processing is performed in S318 in the recording medium 123 as an image file. Also, the system control unit 101 records, in the header of the image file, information about which photographing mode is set to photograph the photographed image, and information about what photographing parameter is used in the photographing and/or the image processing. By reading the header of the image file recorded in this manner, it is possible to determine, at the time of reproduction, in which photographing mode, and by what setting, the image included in the image file is photographed. For example, it is possible to determine, at the time of reproduction, whether or not the photographing is performed with the effect shot function being on, and which item of which function is set to what setting value to perform the photographing.

In S321, the system control unit 101 determines whether or not the reproducing button 57 is pressed down. In the case the reproducing button 57 is pressed down, the process proceeds to S322; otherwise, the process proceeds to S323. In S322, the system control unit 101 performs a reproduction mode process. The details of the reproduction mode process are given later with reference to FIG. 12.

In S323, the system control unit 101 determines whether or not there is a termination event. As the termination event, there are operation of turning off the power supply, detection of zero remaining battery level, execution of auto power off on condition that there is no operation for a predetermined period of time, and the like. In the case there is no termination event, the process returns to S301 to be repeated, and in the case there is a termination event, the photographing mode process is terminated.

FIG. 4 is a flow chart of a photographing setting process. This process is the details of the photographing setting process of S304 described with reference to FIG. 3. Moreover, this process is realized by the programs recorded in the non-volatile memory 114 being decompressed in the system memory 113, and the system control unit 101 executing the programs.

In S401, the system control unit 101 displays a photographing setting screen on the display unit 111.

FIG. 8A shows an example display of the photographing setting screen where the current photographing mode is the CA mode. On the display unit 111, items 801 to 804 are vertically arranged on the right side of the screen as main items for the photograph settings which can be selected (a main item menu). The main items include a first item, a second item, a third item, and a fourth item. Of these items, the item 802 is for the ambience function, the item 803 is for the creative filter, and the item 804 is for the effect shot. One of the main items is displayed being selected by a cursor. In the example of FIG. 8A, the cursor is over the item 803 for the creative filter, and the item 803 is selected. On the lower part of the screen, there are options regarding the setting values of the item, among the main items 801 to 804, under the cursor (the selected main item), the options being lower items (a first setting menu). In the example of FIG. 8A, since the selected main item is the item 803 for the creative filter, lower items 811 to 818 (a setting value group) for the creative filter are displayed on the lower part of the screen (a menu for lower items). Additionally, in the case the live view is on, the main items 801 to 804, the lower items 811 to 818, and a dialogue for indicating the selected main item are displayed, being superimposed on the live view image.

FIG. 8C shows an example display of the photographing setting screen where the current photographing mode is the P mode. Since the mode is the P mode, and the ambience function and the effect shot are invalid and cannot be used, corresponding items 802 and 804 are not displayed. On the other hand, since the picture style which is invalid in the CA mode is enabled, a main item 805, which is an item for the picture style, is displayed. The example that is illustrated shows a state where the cursor is over the item 805 for the picture style. As the lower items, lower items 821 to 825, which are the lower items for the picture style, are displayed, and among these, the cursor for the lower item is displayed at the item 821 (a second setting menu). In the case the lower items 821 to 825 are displayed, the lower items 811 to 818 for the creative filter, which are the lower items of another main item (upper item), are not displayed on the same screen.

In S402, the system control unit 101 determines whether or not one of the up/down keys is pressed down. In the case an up/down key is pressed down, the process proceeds to S403; otherwise, the process proceeds to S407.

In S403, the system control unit 101 refers to the system memory 113, and determines whether or not the effect shot is on. In the case of on, the process proceeds to S404; otherwise, the process proceeds to S405. Additionally, when the current photographing mode is other than the CA mode, the effect shot is invalid and cannot be used, and thus, the effect shot is assumed to be off.

In S404, the system control unit 101 moves the cursor to a main item other than those for the creative filter, the picture style, and the ambience function, among the main items that are displayed, according to the operation of the up/down keys.

In S405, the system control unit 101 moves the cursor to any one of the main items that are enabled in the current photographing mode, including the items for the creative filter, the picture style, and the ambience function, according to the operation of the up/down keys.

In S406, the system control unit 101 displays the lower items for the main item selected by the cursor which is moved in S404 or S405, on the lower part of the screen of the display unit 111. A cursor is displayed on one of a plurality of lower items that are displayed. Additionally, as the lower items for the effect shot, “ON” and “OFF” are to be displayed as the options.

As described, the main item which is selected can be changed according to the operation of the up/down key, and in the case the effect shot is on, the main items for the creative filter, the picture style, and the ambience function, among the main items, are invalid and cannot be selected. Thus, discrepancy between the settings of the creative filter, the picture style, and the ambience function, and the settings of the effect shot is prevented.

In S407, the system control unit 101 determines whether or not the creative filter is currently selected (whether or not the cursor is over the main item for the creative filter). In the case the creative filter is selected, the process proceeds to S408, and a creative filter setting process (described later with reference to FIG. 5) is performed.

In S409, the system control unit 101 determines whether or not the ambience function is currently selected (whether or not the cursor is over the main item for the ambience function). In the case the ambience function is selected, the process proceeds to S410, and an ambience setting process is performed. The ambience setting process is different from the process for the creative filter with respect to only the parameters that can be set, and the operation method is substantially the same as that of the creative filter and description thereof is omitted.

In S411, the system control unit 101 determines whether or not the picture style is currently selected (whether or not the cursor is over the main item for the picture style). In the case the picture style is selected, the process proceeds to S412, and a picture style setting process (described later with reference to FIG. 6) is performed.

In S412, the system control unit 101 determines whether or not a main item for other than the creative filter, the picture style, the ambience function, and the effect shot (for example, the item 801 for white balance) is selected. In the case of Yes, the process proceeds to S414, and a setting process according to the selected main item is performed.

In S415, the system control unit 101 determines whether or not the effect shot is currently selected among the main items (whether or not the cursor is over the main item for the effect shot). In the case the effect shot is selected, the process proceeds to S416; otherwise, the process proceeds to S422. Additionally, in the case the current photographing mode is other than the CA mode, the main item for the effect shot is not displayed, and thus, the determination in S415 is No.

In S416, the system control unit 101 determines whether or not a right/left key is pressed down. In the case it is determined that a right/left key is pressed down, the process proceeds to S417; otherwise, the process proceeds to S422.

In S417, the system control unit 101 moves the cursor for the lower items according to the pressing of the right/left keys to determine whether or not the cursor moves to “ON”. In the case of movement to “ON”, the process proceeds to S418; otherwise (that is, in the case of movement to “OFF”), the process proceeds to S420.

In S418, the system control unit 101 moves the cursor for the lower items to “ON”, and sets the effect shot to ON. When the effect shot is set to ON, that the setting is “ON” is recorded in the system memory 113.

In S419, the system control unit 101 grays out, and disables, the item 804 for the creative filter, the item 802 for the picture style, and the item 803 for the ambience function, among the main items displayed on the photographing setting screen. A user is thereby allowed to identify that, when the effect shot is on, the creative filter, the picture style, and the ambience function are invalid and cannot be selected.

In S420, the system control unit 101 moves the cursor for the lower items to “OFF”, and sets the effect shot to OFF. When the effect shot is set to OFF, that the setting is “OFF” is recorded in the system memory 113.

In S421, the system control unit 101 cancels the gray out display of the item 804 for the creative filter, the item 802 for the picture style, and the item 803 for the ambience function, among the main items displayed on the photographing setting screen, and updates the display in such a way that that the items are valid can be distinguishable.

In S422, the system control unit 101 determines whether or not the SET button 90 is pressed down. In the case the SET button 90 is not pressed down, the process returns to S402 to repeat the process. In the case the SET button 90 is pressed down, the photographing setting screen is hidden, and the process proceeds to S305 of FIG. 3.

FIG. 5 shows a flow chart of a creative filter setting process. This process is the details of the process of S408 described with reference to FIG. 4. Moreover, this process is realized by the programs recorded in the non-volatile memory 114 being decompressed in the system memory 113, and the system control unit 101 executing the programs.

In S501, the system control unit 101 determines whether or not a right/left key is pressed down. In the case a right/left key is pressed down, the process proceeds to S502; otherwise, the process proceeds to S503.

In S502, the system control unit 101 moves the cursor for the lower items to any of the displayed lower items 811 to 818, according to the pressing of a right/left key, and changes the setting to the setting indicated by the lower item under the cursor.

In S503, the system control unit 101 determines whether or not the information display switching button 55 is pressed down. In the case the information display switching button 55 is pressed down, the process proceeds to S504; otherwise, the process of FIG. 5 is terminated, and the process proceeds to S415 of FIG. 4 described above.

In S504, the system control unit 101 displays a filter effect level screen (a setting screen for filter level) on the display unit 111. FIG. 8B shows an example display of the filter effect level screen.

In S505, the system control unit 101 determines whether or not a right/left key is pressed down. In the case it is determined that a right/left key is pressed down, the process proceeds to S506; otherwise, the process proceeds to S507.

In S506, the system control unit 101 increases or decreases the filter level according to the pressing of a right/left key. That is, the filter effect level setting is changed.

In S507, the system control unit 101 determines whether or not the information display switching button 55 is pressed down. In the case the information display switching button 55 is not pressed down, the process returns to S505. In the case the information display switching button 55 is pressed down, the filter effect level setting screen is closed (hidden), the photographing setting screen is displayed, and the process of FIG. 5 is terminated and the process proceeds to S415 of FIG. 4 described above.

FIG. 6 shows a flow chart of a picture style setting process. This process is the details of the process of S412 described with reference to FIG. 4. Moreover, this process is realized by the programs recorded in the non-volatile memory 114 being decompressed in the system memory 113, and the system control unit 101 executing the programs.

In S601, the system control unit 101 determines whether or not a right/left key is pressed down. In the case a right/left key is pressed down, the process proceeds to S602; otherwise, the process proceeds to S603.

In S602, the system control unit 101 moves the cursor for the lower items to any of the displayed lower items, according to the pressing of a right/left key, and changes the setting to the setting indicated by the lower item under the cursor.

In S603, the system control unit 101 determines whether or not the information display switching button 55 is pressed down. In the case the information display switching button 55 is pressed down, the process proceeds to S604; otherwise, the process of FIG. 6 is terminated, and the process proceeds to S415 of FIG. 4 described above.

In S604, the system control unit 101 displays a picture style detail setting screen on the display unit 111. FIG. 8D shows an example display of the picture style detail setting screen. A plurality of detail setting items is displayed on the right side of the screen. On the lower part of the screen, allowable values (a setting bar for the setting values) of the item which is under the cursor and selected (in the illustrated example, “sharpness”) are displayed.

In S605, the system control unit 101 displays a cursor over one of the plurality of detail setting items displayed on the right side of the picture style detail setting screen.

In S606, the system control unit 101 displays the value that is currently set among the allowable values displayed on the lower side of the screen according to the detail setting item selected on the picture style detail setting screen. In the example of FIG. 8D, the position indicated by an upside down triangle display item is the value that is currently set.

In S607, the system control unit 101 determines whether or not an up/down key is pressed down. In the case an up/down key is pressed down, the process proceeds to S608; otherwise, the process proceeds to S609.

In S608, the system control unit 101 moves the cursor for the detail setting items according to the pressing of the up/down key (the item which is selected, among the plurality of detail setting items, is changed).

In S609, the system control unit 101 determines whether or not a right/left key is pressed down. In the case it is determined that a right/left key is pressed down, the process proceeds to S610; otherwise, the process proceeds to S611.

In S610, the system control unit 101 changes, according to the pressing of the right/left key, the setting value of the detail setting item which is selected to any of the allowable values displayed on the lower part of the screen. The value that is set is stored in the system memory 113.

In S611, the system control unit 101 determines whether or not the information display switching button 55 is pressed down. In the case the information display switching button 55 is not pressed down, the process returns to S606. In the case the information display switching button 55 is pressed down, the picture style detail setting screen is closed (hidden), the photographing setting screen is displayed, and the process of FIG. 6 is terminated and the process proceeds to S415 of FIG. 4 described above.

Heretofore, the setting methods with respect to the creative filter, the ambience, and the picture style have been described. In order to switch a setting item belonging to a different function among the creative filter, the ambience, and the picture style, a user has to perform a complicated operation, such as switching of the photographing modes or selection/change of the main item. Also, without understanding the parameters that can be set in each of the functions of the creative filter, the ambience, and the picture style, and what effect can be achieved by which parameter, it is difficult to grasp which function should be used, and effective use is difficult. Accordingly, a plurality of patterns of representative settings are preset as the photograph settings (setting parameters) which is set in the hierarchy of any of the creative filter, the ambience, and the picture style. The effect shot provides a simple use method according to which one has only to select from the patterns.

FIG. 7 shows a flow chart of an effect switching process, which is a process that is performed when the main dial 50 is rotated in a case where the effect shot is on. This process is the details of the process of S311 of FIG. 3. According to the effect shot, the setting is switched in the order (the order of setting N) shown in the table of FIG. 10 according to the rotation operation of the main dial 50. FIG. 10 is a table in which the switching order of the effect switching process and the setting values are associated, and which is stored in the non-volatile memory 114. There are at least 18 patterns of setting value (a first setting value, a second setting value, a third setting value, a fourth setting value, a fifth setting value, a sixth setting value, a seventh setting value, an eighth setting value, a ninth setting value, a tenth setting value, eleventh to eighteenth setting values).

Moreover, this process is realized by the programs recorded in the non-volatile memory 114 being decompressed in the system memory 113, and the system control unit 101 executing the programs.

In S701, the system control unit 101 determines whether or not the rotation direction of the main dial 50 is clockwise. In the case clockwise rotation is determined, the process proceeds to S702; otherwise (that is, in the case of rotation operation in the anti-clockwise direction), the process proceeds to S705.

In S702, the system control unit 101 increments a variable N held in the system memory 113 by one (the variable is incremented by one every time operation of the dial by one click is performed). The variable N is a numerical value corresponding to the place in the order of the selected setting, and a value, in the order of setting shown in FIG. 10, corresponding to the variable N is set.

In S703, the system control unit 101 determines whether or not the variable N has exceeded the largest value (maximum value) in the order of setting in the table shown in FIG. 10. In the case it is determined that the maximum value is exceeded, the process proceeds to S704, and N is set to one, and in the case the maximum value is not exceeded, the process proceeds to S708.

On the other hand, in S705, the system control unit 101 decrements the variable N held in the system memory 113 by one (the variable is decremented by one every time operation of the dial by one click is performed).

In S706, the system control unit 101 determines whether or not the variable N is zero or smaller. In the case the variable is zero or smaller, the process proceeds to S707, and N is set to the maximum value, and in the case the value is not zero or smaller, the process proceeds to S708.

In S708, the system control unit 101 sets the setting pattern (a setting item and a setting value) whose place in the order of setting is N, among the setting patterns in the table of FIG. 10.

In S709, the system control unit 101 displays the setting item and the setting value set in S708, and the function name on the display unit 111.

FIGS. 9A to 9C show example displays on the display unit 111 where the settings are switched by the effect switching process.

FIG. 9A is an example display where the setting pattern whose place in the order of setting is one is set. That the function name is “creative filter”, the setting item name is “rough monochrome”, and the setting value is standard (middle value of three stages) are displayed. This setting is set when the variable N is one. Also, an operation guidance indicating that switching to another setting is possible by the operation of the main dial 50 is displayed at the lower part of the screen.

FIG. 9B is an example display where the setting pattern whose place in the order of setting in FIG. 10 is two is set. That the function name is “ambience”, the setting item name is “sharp and vivid”, and the setting value is high (the maximum value of the three stages) are displayed. This setting is set when N is two, and is set when the main dial 50 is rotated clockwise by one click from the state in FIG. 9A where N is one.

FIG. 9C is an example display where the setting pattern whose place in the order of setting in FIG. 10 is three is set. That the function name is “picture style”, the setting item name is “monochrome”, and the setting value is “3, 0, N, N” are displayed. This setting is set when the variable N is three, and is set when the main dial 50 is rotated clockwise by one click from the state in FIG. 9B where N is two.

In this manner, when the main dial 50 is rotated, the setting is switched in the order of the setting value that can be set by the creative filter function, the setting value that can be set by the ambience, and the setting value that can be set by the picture style. That is, when the main dial is rotated clockwise by one click from the state where a setting pattern (for example, N=1) for the creative filter is set, the setting is switched to a setting pattern (N=2) of the ambience. Switching to another setting pattern belonging to the same creative filter in the table of FIG. 10 does not take place by the rotation operation of one click from the state where a setting pattern (for example, N=1) for the creative filter is set. Also, when the main dial is operated in the clockwise direction by one click from the state where a setting pattern (for example, N=7) for the creative filter in the table of FIG. 10 is set, setting is switched to a setting pattern (N=8) for the ambience, which is a different function. In this manner, the table of FIG. 10 is configured in such a way that the settings in the hierarchy of the same function are not consecutive in the order and functions in different hierarchies are sequentially selected, and that various settings appear according to the operation of the main dial. More specifically, the setting patterns are divided into three groups (first to third groups), and the order is such that setting patterns of groups different from the currently set group are sequentially selected according to the operation of the main dial 50. The first group is associated with the setting patterns that are allowed according to the creative filter. The second group is associated with the setting parameters that are allowed according to the ambience function and the picture style function, other than the setting items regarding monochrome. The third group is associated with the setting patterns that are allowed according to the setting item, regarding monochrome, of the picture style function. Additionally, the monochrome settings included in the picture style include many detail settings, and also the photographing effects of the monochrome settings are easily visible, and thus, the third group is configured only from the monochrome settings. That is, the setting values (setting patterns) included in the picture style are grouped into a first group (the setting patterns in the second group) configured from setting values other than the monochrome settings, and a second group (the setting patterns in the third group) configured from setting values of the monochrome settings.

In this manner, in the effect shot, values which can be set in respective different photographing modes or under respective different hierarchies (main items) in the case the effect shot is not used can be selected according to the operation of the main dial 50 in the order across the photographing modes or the hierarchies. Also, the order is such that the setting patterns of different item groups are cyclically set. This enables even a user who is not used to the operation of the digital camera 100 to grasp, by rotating the main dial 50, that settings for applying image processing for achieving various effects are possible. That is, the user can easily use various setting patterns. Also, use of settings of the effect shot is expected to enable the user to understand functions such as the creative filter, the ambience, and the picture style. Then, the user can eventually be made to directly set functions such as the creative filter, the ambience, and the picture style without using the effect shot, and perform photographing by more finely adjusting the image quality.

Additionally, the effect shot described above is a function allowing setting regarding image processing on a photographed image. The present exemplary embodiment can be applied to other than the setting items for the image processing. That is, also with respect to an apparatus other than the image capturing device, setting patterns which can be set under different items (in other upper hierarchies) of the apparatus can be allowed to be sequentially selected and set without switching the operation modes or the items (hierarchies). At this time, the order of selection is such that the setting values of different items are adjacent to one another. This enables even a beginner user to easily use settings which can be set in various hierarchies of the apparatus. That is, the user can use various functions by simple operations.

<Reproduction Mode Process>

A reproduction/display method of a photographed image which is photographed in the manner described above, with the effect shot being on (hereinafter, referred to as an image photographed by the effect shot) will be described. As described above, in the effect shot, an image obtained by applying image processing on a photographed image by using any of the parameters that are allowed by the creative filter, the ambience function, and the picture style is recorded. Accordingly, simply displaying to the effect that the image photographed by the effect shot has been photographed by the effect shot does not allow one to know what effect is applied at the time of photographing. Thus, in the present exemplary embodiment, an image photographed by the effect shot is reproduced/displayed, and also, which photographing parameter of which function is used in the photographing is displayed. Also, as described above, the photographing modes in which the creative filter, the ambience function, and the picture style can be used are different. Thus, even if a user knows that a setting parameter which may be set in the creative filter, the ambience function, or the picture style is used, the user may not know what operation may replicate the setting. More specifically, it is not known which photographing mode is to be set to use a desired function, and which photographing mode does not allow use of the desired function. Moreover, even if which photographing mode is to be set is known, the operation method of setting the desired photographing mode is not known. Accordingly, in the present exemplary embodiment, at the time of reproducing/displaying an image photographed by the effect shot, which photographing parameter of which function is used in the photographing is displayed. Moreover, which function allows setting of the setting parameter used for the image photographed by the effect shot, which photographing mode allows use of the function, and how the photographing mode is set are displayed.

FIG. 11A shows an example display in the reproduction mode of an image photographed by the effect shot, on the display unit 111. An effect shot icon 1101 indicates that the image which is being reproduced/displayed is an image which is photographed with the effect shot being on. When a photographing effect display button included in the operation unit 115 is pressed down by the user in this state, the display of FIG. 11B is obtained.

FIG. 11B shows an example display of a photographing effect of the image photographed by the effect shot, on the display unit 111. A photographing effect dialogue 1102 is displayed, being superimposed on the image. In the photographing effect dialogue, a function name 1103, an item name/setting value display 1104, and an operation key guide 1105 are displayed. The user is allowed to grasp, by the function name 1103, that the image that is currently displayed is an image which is photographed using the settings of the ambience function. Also, the user is allowed to grasp, by the item name/setting value display 1104, that the image is photographed with the lower item, “sharp and vivid”, of the ambience function being set to the maximum value among the three stages of setting value. Also, it can be seen by the operation key guide 1105 that more detailed information can be displayed by pressing the information display switching button 55. When the information display switching button 55 is pressed down by the user in this state, the display of FIG. 11C is obtained.

FIG. 11C shows an example display of an operation method guidance for the function used for the image photographed by the effect shot, on the display unit 111. As an operation method guidance 1106, an operation member icon 1107 representing the mode dial 117, and a balloon 1108 showing a list of icons of the photographing modes included in the SCN mode are displayed. In the operation member icon 1107 and the balloon 1108, icons (photographing mode icons) corresponding to all of the photographing modes that can be set are displayed. Of these photographing mode icons, icons corresponding to the photographing modes that can use the function whose name is displayed in the photographing effect dialogue 1102 are displayed in white, and icons corresponding to the photographing modes that cannot use the function are grayed out. By looking at this display, the user can grasp which photographing mode to use to perform photographing while setting the same function as the function used for the image that is currently reproduced/displayed, that is, the user can grasp that the photographing mode of a photographing mode icon displayed in white is to be set. Additionally, the photographing mode icons that are displayed in white at this time are not restricted to the photographing mode which is set at the time of photographing the displayed image. That is, the operation modes that are capable of setting the photographing mode used at the time of photographing the displayed image, including operation modes other than the operation mode which is set at the time of photographing the displayed image, are displayed in white. Furthermore, it is also possible to grasp a photographing mode, among the photographing modes that can be set, which is not capable of setting the same function as the function which is used for the image that is currently reproduced/displayed (the grayed out photographing mode). Also, it is possible to grasp, by the operation member icon 1107 and the balloon 1108, turning the photographing mode dial to which position can set the photographing mode that is displayed by a white icon. That is, it is also possible to grasp the operation method of setting the photographing mode allowing the use of the function which is used for the image that is currently reproduced/displayed. When an up/down key is pressed down in this state, the display of FIG. 11D is obtained. Also, when the information display switching button 55 is pressed down in this state, the display of FIG. 11A is obtained.

FIG. 11D shows an example display of an effect detail guidance regarding the function which is used for the image photographed by the effect shot, on the display unit 111. As a function guide 1109, what kind of function the function which can use the setting parameter used for the image that is currently displayed and which is displayed in the photographing effect dialogue 1102 is displayed. In the example of FIG. 11D, what the function of the ambience is displayed. Giving an explanation in writing helps the user to understand the function. As a lower item guide 1110, the setting of the setting item which is used for the image that is currently displayed and which is displayed in the photographing effect dialogue 1102 is displayed. Giving an explanation in writing helps the user to understand the function.

The details of the reproduction operation described above will be given.

FIG. 12 shows a flow chart of a reproduction mode process. This process is the details of the process of S322 described with reference to FIG. 3. Moreover, this process is realized by the programs recorded in the non-volatile memory 114 being decompressed in the system memory 113, and the system control unit 101 executing the programs.

In S1201, the system control unit 101 reads, as an image to be initially displayed, an image file whose file number is n from the recording medium 123. An image to be initially displayed is the image which is last photographed, or an image which is displayed at the end at the time of previous reproduction mode, and the file number of the image is made the initial value of n.

In S1202, the system control unit 101 reads the attribute information (header information) of the n-th image file which is read. As described with reference to S320 of FIG. 3, in the attribute information, information about which photographing mode is set to photograph the photographed image, and information about what photographing parameter is used in the photographing and/or the image processing are recorded.

In S1203, the system control unit 101 displays, on the display unit 111, the image of the image file which is read. Here, single display according to which all of one image fits in the display unit 111 is assumed to be performed.

In S1204, the system control unit 101 determines, based on the attribute information which is read in S1202, whether or not the n-th image which is read is an image which is photographed with the effect shot being on. In the case of an image which is photographed with the effect shot being on, the process proceeds to S1205; otherwise, the process proceeds to S1216.

In S1205, the system control unit 101 displays the effect shot icon 1101 indicating that the image is photographed by the effect shot. This icon is also an icon indicating that more detailed information can be displayed. The example display at this time is the example display of FIG. 11A described above.

In S1206, the system control unit 101 determines whether or not the photographing effect display button included in the operation unit 115 is pressed down. In the case the photographing effect display button is pressed down, the process proceeds to S1207; otherwise, the process proceeds to S1216.

In S1207, the system control unit 101 displays the photographing effect dialogue 1102 by superimposing the same on the image displayed on the display unit 111. More specifically, the function name, the item name, and the setting value that were set at the time of photographing of the displayed image are identified based on the attribute information read in S1202, and these pieces of information are displayed in the photographing effect dialogue 1102. The example display at this time is the example display of FIG. 11B described above.

In S1208, the system control unit 101 determines whether or not the information display switching button 55 is pressed down. In the case it is determined that the information display switching button 55 is pressed down, the process proceeds to S1209; otherwise, the process proceeds to S1214.

In S1209, the system control unit 101 displays the operation method guidance 1106 by superimposing the same on the image displayed on the display unit 111. More specifically, the function (the type of the main item among the creative filter, the picture style, and the ambience) that is set at the time of photographing of the displayed image is identified based on the attribute information read in S1202. Then, the photographing mode that allows the use of the identified function without the use of the effect shot is identified based on the information stored in the non-volatile memory 114. Then, image data for displaying the operation member icon 1107 representing the mode dial 117 and the icons of the photographing modes included in the SCN mode are read from the non-volatile memory 114 and are displayed. At this time, the icons corresponding to the photographing modes allowing the use of the identified function are displayed in white, and the icons corresponding to other photographing modes are displayed in gray. The example display at this time is the example display of FIG. 11C described above.

In S1210, the system control unit 101 determines whether or not an up/down key is pressed down. In the case an up/down key is pressed down, the process proceeds to S1211; otherwise, the process proceeds to S1212.

In S1211, in the case the operation method guidance 1106 is displayed on the display unit, the system control unit 101 switches the display to the effect detail guidance, and in the case the effect detail guidance is displayed, the system control unit 101 switches the display to the operation method guidance 1106. The example display of the effect detail guidance is the example display of FIG. 11D described above.

In S1212, the system control unit 101 determines whether or not the information display switching button 55 is pressed down. In the case the information display switching button 55 is pressed down, the process proceeds to S1213; otherwise, the process returns to S1210.

In S1213, the system control unit 101 hides the operation method guidance or the effect detail guidance, proceeds to S1215 to also hide the photographing effect dialogue 1102, and proceeds to S1205 to return to the display state in FIG. 11A.

In S1214, the system control unit 101 determines whether or not the photographing effect display button included in the operation unit 115 is pressed down. In the case the photographing effect display button is pressed down; the process proceeds to S1215; otherwise, the process returns to S1208.

In S1215, the system control unit 101 also hides the photographing effect dialogue 1102, and proceeds to S1205 to return to the display state in FIG. 11A.

On the other hand, in S1216, the system control unit 101 determines whether or not there is an end instruction for the single reproduction. An instruction to perform image display in multiscreen form of displaying a plurality of images on the display unit 111, an instruction to display an image on the display unit 111 in an enlarged manner, an instruction to transition to another operation mode such as a photographing mode, and the like are assumed to be the end instruction for the single reproduction. When the end instruction for the single reproduction is issued, the present process is terminated. In the case there is no end instruction for the single reproduction, the process proceeds to S1217.

In S1217, the system control unit 101 determines whether or not there is an image feeding instruction (an instruction to switch the displayed image to another image). The image feeding instruction can be issued by pressing of a right/left key, for example. In the case the image feeding instruction is issued, the process proceeds to S1218; otherwise, the process returns to S1204.

In S1218, the system control unit 101 increments a variable n for performing image feeding held in the system memory 113 by one, proceeds to S1201, and performs the display processing for the next image. Additionally, in the case of reverse-feeding of the image, the variable n is decremented by one.

According to the reproduction mode process of the above-described exemplary embodiment, a user is enabled to identify in which photographing mode (photograph setting) an image that is being reproduced/displayed is photographed. Also, it is possible to know the operation as to how to set the photograph setting which is used at the time of photographing the image that is being reproduced/displayed. Furthermore, it is possible to understand what effect may be achieved by the photograph setting.

Additionally, control of the system control unit 101 may be performed by one piece of hardware, or the process may be assigned to a plurality of pieces of hardware to perform control of the entire device.

Moreover, the present disclosure has been described in detail based on the above-described embodiment(s), but is not restricted to these specific embodiments, and various modes within the scope of the disclosure are also included in the present disclosure. Furthermore, each of the embodiments described above merely illustrates one embodiment of the present disclosure, and the embodiments can be combined as appropriate.

Furthermore, in the embodiments described above, examples have been described assuming application of the present disclosure to the digital camera 100, but these examples are not restrictive. A process that is substantially the same as the photographing mode process described above may be applied to any electronic apparatus which allows setting of different setting values in the hierarchies of a plurality of different items, without being restricted to settings related to photographing or image processing. For example, application to setting related to image display, and setting related to communication is also possible. Also, a process that is substantially the same as the reproduction mode described above may be applied to any display control device that is capable of reading the attribute information of a photographed image, and of displaying the photographed image. That is, the present disclosure can be applied to a personal computer, a PDA, a mobile phone terminal, a portable image viewer, a printer apparatus including a display, a digital photo frame, a music player, a game console, an electronic book reader, and the like.

### Other Embodiments

Additional embodiments can also be realized by a computer of a system or apparatus that reads out and executes computer executable instructions recorded on a storage medium (e.g., computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, a user is enabled to use various functions by simple operations. Furthermore, according to the present disclosure, a user can grasp what operation is normally performed to achieve the same setting as that used at the time of generating a photographed image.

While the present disclosure has been described with reference to exemplary embodiments, it is to be understood that these embodiments are not seen to be limiting. The scope of the following claims is to be accorded the broadest interpretation so as to encompass all such modifications and equivalent structures and functions.

This application claims the benefit of Japanese Patent Application No. 2013-053247, filed Mar. 15, 2013, and Japanese Patent Application No. 2013-053248, filed Mar. 15, 2013, which are hereby incorporated by reference herein in their entirety.

What is claimed is:

1. An electronic apparatus comprising:
a setting unit configured to set any of setting values included in a first item in a hierarchy of a first setting menu, and to set any of setting values included in a second item in a hierarchy of a second setting menu; and
a control unit configured to perform control, according to a specific operation, so as to switch to selection of a second setting value included in the second item in a case a first setting value included in the first item is selected, and to switch to selection of a fourth setting value included in the second item in a case a third setting value included in the first item is selected.

2. The electronic apparatus according to claim 1,
wherein the setting unit is further configured to set any of setting values included in a third item in a hierarchy of a third setting menu, and
the control unit performs control, according to the specific operation, so as to switch to selection of a sixth setting value included in the third item in a case a fifth setting value included in the first item is selected, and to switch to selection of a seventh setting value included in the second item in a case the sixth setting value included in the third item is selected.

3. The electronic apparatus according to claim 1, wherein at a time of switching selection of a setting value under control of the control unit, a setting value included in the first item and a setting value included in the second item are not displayed on a same screen.

4. The electronic apparatus according to claim 1,
wherein the setting values included in the second item include setting values of a first group including the second setting value and the fourth setting value, and setting values of a second group different from the first group, and
wherein the control unit performs control, according to the specific operation, so as to switch to selection of an eighth setting value included in the second group in a case the second setting value is selected, and to switch to selection of a ninth setting value included in the second group in a case the fourth setting value is selected.

5. The electronic apparatus according to claim 1, further comprising:
a mode setting unit configured to set an operation mode from among a plurality of operation modes including a first operation mode and a second operation mode,
wherein in the first operation mode, setting by the second setting menu by the setting unit is enabled, and in the second operation mode, setting by the second setting menu by the setting unit is disabled.

6. The electronic apparatus according to claim 5,
wherein a third operation mode is included in the plurality of operation modes, and
wherein in the second operation mode, setting by the first setting menu by the setting unit is enabled, and in the third operation mode, setting by the first setting menu by the setting unit is disabled.

7. The electronic apparatus according to claim 6, wherein the control unit performs the control in a case a specific setting is performed by a fourth setting menu, is not able to perform setting by the fourth setting menu by the setting unit in the first operation mode, and is able to perform setting by the fourth setting menu by the setting unit in the second operation mode.

8. The electronic apparatus according to claim 5, wherein the plurality of operation modes are a plurality of different photographing modes for performing image capturing by an image capturing unit.

9. The electronic apparatus according to claim 1, wherein the control unit is configured to perform the control in a case a specific setting is performed by a fourth setting menu.

10. The electronic apparatus according to claim 1, wherein the first item and the second item are both items related to image processing, and are items allowing setting of one of mutually different setting value groups.

11. The electronic apparatus according to claim 1, wherein the first item and the second item are both items related to image processing, and are items allowing setting of one of mutually different setting value groups, wherein, of the setting values included in the second item, the setting values of the first group are setting values for image processing different from image processing for generating a monochrome image, and the setting values of the second group are setting values for the image processing for generating a monochrome image.

12. The electronic apparatus according to claim 1, further comprising an image capturing unit.

13. A control method of an electronic apparatus, the method comprising:
setting any of setting values included in a first item in a hierarchy of a first setting menu, and setting any of setting values included in a second item in a hierarchy of a second setting menu; and
performing control, according to a specific operation, so as to switch to selection of a second setting value included in the second item in a case a first setting value included in the first item is selected, and to switch to selection of a fourth setting value included in the second item in a case a third setting value included in the first item is selected.

14. A computer readable medium storing computer-executable instructions for causing a computer to execute a control method of an electronic apparatus, the method comprising:
setting any of setting values included in a first item in a hierarchy of a first setting menu, and setting any of setting values included in a second item in a hierarchy of a second setting menu; and
performing control, according to a specific operation, so as to switch to selection of a second setting value included in the second item in a case a first setting value included in the first item is selected, and to switch to selection of a fourth setting value included in the second item in a case a third setting value included in the first item is selected.

15. An electronic apparatus comprising:
a control unit configured to perform control so as to display an image;
a reading unit configured to read attribute information of the image, the attribute information including information about a setting at a time of photographing the image; and
a display control unit configured to perform control so as to display a guidance indicating an operation method of an image capturing device for achieving the setting at the time of photographing the image, based on the attribute information of the image.

16. The electronic apparatus according to claim 15, wherein the display control unit performs control based on the attribute information of the image so as to display the guidance for enabling identification of a plurality of operation modes allowing setting of the setting at the time of photographing the image, including an operation mode other than an operation mode that is set at the time of photographing the image.

17. The electronic apparatus according to claim 15, wherein the display control unit indicates the operation method by displaying an image representing an operation member of the image capturing device in the guidance.

18. The electronic apparatus according to claim 15, wherein the display control unit performs control so as to display an explanation about a function name, and a setting value that is set, of the setting at the time of photographing the image.

19. The electronic apparatus according to claim 15, wherein the display control unit performs control based on the attribute information so as to display the guidance, in a case the image is an image photographed by using a function allowing setting of any of a setting value included in a first item that can be set in a hierarchy of a first setting menu and a setting value included in a second item that can be set in a hierarchy of a second setting menu.

20. The electronic apparatus according to claim 15, wherein the electronic apparatus is an image capturing device including an image capturing unit.

21. The electronic apparatus according to claim 15, wherein the setting is a setting related to image processing applied to the image.

22. The electronic apparatus according to claim 15, wherein the display control unit performs control so as to display the guidance together with the image.

23. An electronic apparatus comprising:
a control unit configured to perform control so as to display an image;
a reading unit configured to read attribute information of the image, the attribute information including information about a setting at a time of photographing the image; and
a display control unit configured to perform control so as to display a guidance indicating a plurality of operation modes allowing setting of the setting at the time of photographing the image, including an operation mode other than an operation mode that is set at the time of photographing the image, based on the attribute information of the image.

24. The electronic apparatus according to claim 23, wherein the display control unit performs control based on the attribute information of the image so as to display, in the guidance, an operation mode not allowing setting of the setting at the time of photographing the image, in such a way that that setting of the setting is not allowed is distinguishable.

25. The electronic apparatus according to claim 23, wherein the operation mode is a photographing mode of an image capturing device.

26. A control method of an electronic apparatus, the method comprising:
performing control so as to display an image;
reading attribute information of the image, the attribute information including information about a setting at a time of photographing the image; and
performing control so as to display a guidance indicating an operation method of an image capturing device for achieving the setting at the time of photographing the image, based on the attribute information of the image.

27. A control method of an electronic apparatus, the method comprising:
performing control so as to display an image;
reading attribute information of the image, the attribute information including information about a setting at a time of photographing the image; and
performing control so as to display a guidance indicating a plurality of operation modes allowing setting of the setting at the time of photographing the image, including an operation mode other than an operation mode that is set at the time of photographing the image, based on the attribute information of the image.

28. A computer readable medium storing computer executable instructions for causing a computer to execute a control method of an electronic apparatus, the method comprising:
performing control so as to display an image;
reading attribute information of the image, the attribute information including information about a setting at a time of photographing the image; and
performing control so as to display a guidance indicating an operation method of an image capturing device for achieving the setting at the time of photographing the image, based on the attribute information of the image.

29. A computer readable medium storing computer executable instructions for causing a computer to execute a control method of an electronic apparatus, the method comprising:
performing control so as to display an image;
reading attribute information of the image, the attribute information including information about a setting at a time of photographing the image; and
performing control so as to display a guidance indicating a plurality of operation modes allowing setting of the setting at the time of photographing the image, including an operation mode other than an operation mode that is set at the time of photographing the image, based on the attribute information of the image.
